(19) United States
(12) Patent Application Publication
(10) Pub. No.: US 2010/0315635 A1
(43) Pub. Date: Dec. 16, 2010

(54) DEVICE AND METHOD FOR MEASURING STATIC AND DYNAMIC SCATTERED LIGHT IN SMALL VOLUMES

(76) Inventors: Christoph Janzen, Huckehoven (DE); Reinhard Noll, Aachen (DE); Walter Uhl, Asslar (DE); Kurt Hoffmann, Amel (BE)

Correspondence Address: DARDI & HERBERT, PLLC, Moore Lake Plaza, Suite 205, 1250 East Moore Lake Drive, Fridley, MN, 55432, US

(21) Appl. No.: 12/667,601

(22) PCT Filed: Jul. 4, 2008
(86) PCT No.: PCT/EP2008/005468

§ 371 Date: Aug. 30, 2010

(30) Foreign Application Priority Data
Jul. 5, 2007 (DE) 10 2007 031 244.1

(51) Int. Cl. G01J 3/28; G01N 21/47

(52) U.S. Cl. 356/326; 356/300

(57) ABSTRACT

The invention relates to a device for measuring scattered light, comprising at least one focusing element provided with electromagnetic radiation that can be focused on a sample, a detector and a detector optical system with which electromagnetic radiation scattered by the sample can be conducted to the detector. The device is characterized in that it comprises means for forming an annular beam such that said annular beam can be focused on a focus point inside the sample by the at least one focusing element and that electromagnetic radiation scattered by the sample can be detected by the detection optical system, said electromagnetic radiation dispersing inside the area surrounded by the annular beam.

### TECHNICAL FIELD OF APPLICATION

The present invention relates to a device, a measuring system and a process for performing light scattering measurements, especially measurements of static and dynamic light scattering. Preferred fields of application are those in which it is required to perform a large number of measurements in automated operations, such as in the examination of crystallization processes when protein crystals are to be grown.

### DESCRIPTION OF RELATED ART

Light scattering measurements, especially laser light scattering measurements, are already being employed in a wide variety of fields of application, for example, for the characterization of colloids. In the food industry, for cosmetic products or also for polymers or adhesives, the size distribution and stability of colloidal particles play an important role.

Another field of application is the elucidation of the structures of complex proteins and other biomolecules, which is of great importance to the well-aimed development of new medicaments and the examination of the biochemical function of such molecules. Structural elucidation based on X-ray scattering experiments depend on high quality single crystals with diffraction properties, which are usually grown from solutions. The critical step in the growing of protein single crystals essentially consists in finding solution conditions suitable for crystallization. By varying solution parameters, such as the pH value, protein concentration, the composition and concentration of salts and precipitation reagents, temperature etc., the interactions between the dissolved protein molecules are varied, and attractive or repulsive interactions can be adjusted. The examination of the crystallization of proteins has usually been performed empirically to date and represents a bottleneck in the structural elucidation of proteins.

Laser light scattering measurements allow for a direct measurement of the interaction between dissolved proteins that prevails in a crystallization solution and can therefore be employed for the selective finding of optimum solution parameters for crystallization. The so-called osmotic virial coefficient is a thermodynamic quantity that describes the real interactive behavior of dissolved particles as a deviation from the behavior of an ideal solution. Osmotic virial coefficients can be established by means of measurements of static light scattering. The detection of the absolute intensity of scattered light in different solutions having different particle concentrations is necessary for the measuring process. Light reflected from interfaces can very easily disturb the measurement. It is already known that the osmotic virial coefficient is of particular importance to the crystallization of proteins. The probability of successful crystallization is particularly high in a range of values of the osmotic virial coefficient referred to as the “crystallization window”, and particularly low outside this crystallization window.

By means of dynamic light scattering methods, information about the diffusion behavior of dissolved particles and thus the particle size can be obtained. These sizes are substantially changed by an aggregation process. The process of nucleation, which precedes the crystallization, can thus be recognized.

Especially for measurements of static light scattering, it is of key importance to achieve optimum suppression of undesirable fractions of radiation. The latter are mainly caused by reflections from interfaces. The closer the interfaces are to the measuring volume, the more difficult effective suppression becomes.

It has already been known to employ laser light scattering methods for the characterization of macromolecules. Various devices are available for establishing osmotic virial coefficients or molecular weights by means of static light scattering and also for establishing hydrodynamic radius distributions by means of dynamic light scattering. The devices employed today for performing light scattering measurements usually work with glass cuvettes into which sample solutions have to be filled. In most cases, a laser beam is focused into the cuvette, and the light scattered by the examined particles is detected under a defined angle relative to the direction of irradiation (e.g., 90°). There are also systems which allow the detection angle to be changed or scattered light to be collected simultaneously with several detectors under different angles, for example, as described in EP 0 867 711 A2. Typically, round cuvettes are employed for such systems, which are positioned in an index-matching bath (a vessel filled with a liquid having a matched refractive index) for further avoiding reflected fractions in the scattered light. Due to the small difference in the refractive index between the bath liquid and the cuvette wall, a comparatively small fraction of reflected radiation is generated during the transition of the laser beam into the cuvette.

However, the known devices based on cuvettes cannot perform automated highthroughput light scattering measurements since it is usually necessary to fill the cuvettes manually. In the case of precision measurements, the cuvettes employed are made of polished glass and are expensive. For an economical use, they must be reused many times and therefore must be cleaned, causing expenditure. Due to the high demands of the measuring process (for example, there is a problem that surface contaminations on the glass as well as particles in the solution distort the scattered light intensity), this cleaning step is also tedious and difficult to automatize. The problem of cleaning cannot be solved by using disposable cuvettes, for example, plastic cuvettes, since the scattered light caused by the plastic due to its poorer optical properties results in distortions just with the measurements of static light scattering in which absolute light intensities must be determined with high precision. All in all, the handling of cuvettes (positioning in the index-matching bath, cleaning, refilling) is therefore tedious and time-consuming.

The volumes of typical cuvettes for light scattering measurements are on the order of at least 5 to 10 microliters, often even substantially higher. Although the production of cuvettes with even smaller volumes would be technically possible in principle, light scattering cuvettes with nanoliter volumes have not been used to date and are currently not commercially available. The handling of the solutions, which is necessary for the manual performance of individual measurements (manual pipetting, mixing the solutions, filling the solution into the cuvette etc.), requires a minimum volume, which is typically in the microliter range. Also, a substantial scale-reduction of the cuvette volumes does not seem to be required for individual measurements, and in addition, the excitation and detection optical systems of the commercial light scattering devices are not optimized for extremely small cuvette volumes.

However, in the case of serial studies with hundreds or thousands of measurements for the automated crystallization of proteins, a further minimization of the sample volume and thus of the protein consumption is necessary since the proteins often must be recovered with high expenditure and are available only in small amounts. Thus, in the known light scattering measuring systems, the high sample consumption also prevents systematic studies for the optimization of the crystallization conditions on the basis of measurements of static light scattering.

Within the scope of crystallization experiments, protein solutions are often applied in the form of small droplets that either hang from the bottom of a glass slide (“hanging drop”) or sit on the bottom of a sample carrier (“sitting drop”). The curved surfaces caused by the drop shape cause hardly controllable reflections when passed by a laser beam, which is why measurements of static light scattering with droplets have not been performed to date or appeared to be impossible.

The Wyatt Technology Corporation offers a light scattering measuring device for use in microtitration plates, which is only able to perform dynamic measurements, however, not static ones. For recording measurements of dynamic light scattering, signal fluctuations caused by particle movements are evaluated. A signal background that is constant in time and caused by reflections does not disturb the measurement of dynamic light scattering, or only a little so. In contrast, static measurements are based on the recording of absolute intensities of scattered light, and in this case, the influence of reflections on the scattering signals prevents the measurement. However, the device of the Wyatt Technology Corporation is not able to suppress disturbing reflections so strongly as would be necessary for performing measurements of static light scattering.

It is the object of the invention to provide a device and a process for performing light scattering measurements, especially also absolute light scattering measurements, whereby a particularly effective suppression of undesirable fractions of the radiation is achieved, in addition whereby a systematic and particularly highly automated and thus rapid examination of a high number of samples is possible, wherein samples having a very small volume, in particular, can also be examined and used.

### DESCRIPTION OF THE INVENTION

The solution to this technical problem is achieved by a device, a measuring system and a process according to the independent claims. Advantageous embodiments and further embodiments are stated by the dependent claims or can be seen from the following description and exemplary embodiments.

The present device for performing light scattering measurements comprises at least one focusing element by means of which electromagnetic radiation can be focused onto a sample, a detector, and a detection optical system by means of which electromagnetic radiation scattered by the sample can be guided to the detector. According to the invention, it has been recognized that the technical problem can be solved by providing that the device additionally comprises a means for generating an annular beam, that said at least one focusing element can cause the annular beam to be focused on a focal point within the sample, and that the detection optical system can detect electromagnetic radiation scattered by the sample that propagates within the space surrounded by the annular beam.

These features realize a confocal optical system which enables measurements of static and dynamic light scattering in a back-scattering geometry, which means that the detection of the scattering radiation is effected approximately in the same direction from which the excitation laser (or the light source used for excitation) was irradiated (back-scattering direction). In particular, this facilitates a particularly compact construction of the device and renders the device particularly flexible with respect to the sample carriers employed. In particular, this offers the possibility to perform light scattering measurements in measuring geometries with only one optical access. For example, it is possible to examine samples or sample droplets in microtitration plates with glass bottoms. Thus, it can be achieved that a large number of measurements can be performed with a single sample carrier (e.g., microtitration plate). The use of microtitration plates simplifies the use of pipetting robots for the automated filling of individual sample positions. Thus, a comprehensive automatization of the sample preparation and light scattering measurement can be achieved thereby. This offers substantial economical advantages over the devices known from the prior art, also especially because the use of the sample carrier as a disposable article is economical due to the large number of measurements that can be performed with one sample carrier, and thus a complicated cleaning operation as known from the prior art for cuvettes can be dispensed with.

In addition, due to the fact that the device allows for the generation of an annular beam and the focusing of such annular beam, a comparably narrow focusing and thus minimization of the measuring volume can be achieved on the one hand. In this way, it is possible to perform measurements even on samples having particularly small volumes (below 1 μl or on the order of (a few) 100 nl). In addition, due to the comparably small size of the focal volume of the exciting beam, the intensity of irradiation is particularly high for a given total power. Thus, a particularly high scattered radiation per volume element can be produced.

On the other hand, since scattered radiation, especially exclusively scattered radiation, that propagates within the space surrounded by the annular beam can be detected, it is at the same time ensured that a comparably strong suppression of undesirable radiation reflected from surfaces of the sample or the sample carrier can be effected. According to the invention, the exciting radiation can be irradiated into the sample under a very flat angle. Thus, direct reflections at the air/sample carrier interface and the sample carrier/sample liquid interface are also reflected back under a very flat angle. In contrast, the scattered radiation that propagates within the space surrounded by the annular beam will leave the detection volume under a more acute angle. The angular difference between the exciting light and the scattered radiation thus results in a strong suppression of reflections.

The annular beam is generated from a collimated beam having a Gaussian beam profile, and as the radiation source, a laser is preferably used, especially a semiconductor, solid or gas laser operated in continuous mode. The shaping of the annular beam can be achieved by beam expansion in connection with an annular aperture. However, a particularly preferred embodiment provides a beam-shaping optical system comprising two axicones (glass cones) positioned on the optical axis and pointing towards each other with their apices for the shaping of the annular beam. On the entry side, they are centrically illuminated by the laser beam. Such an arrangement has particularly high transmission values, so that the losses from the formation of an annular beam are comparably low.

The focusing element is preferably reflecting and has an annular design. This enables an advantageous arrangement of the detection optical system.

It is advantageous if the focusing element has such a design that an approximately radial-symmetrically formed focus (which is as small as possible) can be generated in the sample, since a particularly high intensity per volume element can be achieved in this way. Since only signals from the overlapping region of the excitation and detection foci are recorded due to the confocal detection, both foci should have about the same size. By its nature, a microscope objective with a fully filled aperture can produce a smaller focus than an annular beam, and therefore, the excitation focus will usually be larger than the detection focus. For this reason, the signal intensity is enhanced if as small as possible an excitation focus is produced and as high as possible an excitation intensity per unit area is provided, since only the inner part of the focus (from the overlapping region) contributes to the signal. For example, a (annular) parabolic mirror may be used as a focusing element. With such a parabolic mirror, it is possible in principle to produce an approximately radial-symmetrically formed focus. However, the boundary layers to be passed by the radiation between the focusing element and the sample are to be taken into account, so that an optimum focusing element is slightly modified in shape with respect to a parabolic mirror and thus corrects the effect of refraction at the glass bottom, or when the beam enters the sample.

The focusing element should have such a design that a focal diameter of smaller than 30 μm, preferably smaller than 20 μm, can be produced (wherein the focal diameter is to be defined by the condition that the laser intensity has decreased at its limits to 1/e times its maximum intensity in the focal center). Due to the small size of the focal diameter, it is possible to examine even extremely small samples of below 1 μl, and in addition, a particularly high scattering radiation per volume element and thus a high overall signal intensity is available thereby. The high degree of focusing allows measurements to be made at a very close distance from interfaces.

Preferably, the detection optical system is arranged within the space surrounded by the annular beam, and in particular, the detection optical system is arranged centrically within this space, or in the center of the optical axis defined by the annular beam and the focusing element. The focus of the detection optical system coincides with the focus of the excitation optical system. Due to such an arrangement, the detection optical system is capable of collecting as high as possible a fraction of the scattered radiation produced and transmit it to the detector without substantial losses. For the collection of the scattered radiation, a microscope objective having a numerical aperture of at least 0.6, preferably at least 0.7, can be employed.

For the majority of proteins interesting for crystallization, it is true that the molecules are substantially smaller (typically a few nm) than the wavelength of the laser light employed (several 100 nm). Therefore, in a first approximation, the scattering intensity is independent of the contemplated angle, and it is possible to collect the scattered radiation over many angles, which therefore in principle does not yield any other results than experiments in which scattered light is collected under one angle only. Thus, a detection optical system having a large numerical aperture is advantageous because a higher signal intensity can be achieved.

In a particularly advantageous embodiment, the detection optical system has such a design as to collect the light scattered from the sample and form it into a collimated beam again. This collimated beam is then focused by means of another optical element, for example, a lens, to a small entrance aperture of the detection system, for example, to the core of an optical waveguide, preferably a single mode fiber. The system has such a design that only radiation originating from a limited region within a predefined detection plane forms a collimated beam and is focused in the plane of the small entrance aperture of the detection system, for example, the front plane of the fiber. The detection plane corresponds to the focal plane of the detection optical system for the inverse direction of the beam path. The limited region has a dimension of less than 10 μm, preferably about 5 μm, especially in the direction perpendicular to the detection axis. It is completely within the focus of the exciting radiation. Scattered radiation from planes other than the predefined detection plane is focused by the focusing optical system in front of or behind the plane of the front surface of the fiber and therefore can enter the fiber only at a very small fraction. For the process to work, the foci of the excitation optical system (parabolic mirror) and detection optical system (microscope objective) must overlap as well as possible in all three directions of space.

Due to this measuring principle, a substantial suppression of undesirable reflection fractions is obtained. In this way, both specular reflections and diffusely scattered radiation generated, for example, on scratches and defects in the glass bottom of the sample carrier are effectively suppressed.

The detection optical system may be or comprise, for example, a multi-lens microscope objective with an adapted numerical aperture. In this case, the collection angle of the objective must be adapted to the angle under which illumination occurs. By selecting the aperture of the microscope objective as large as possible, but a little smaller than the internal limiting aperture of the illumination, it is ensured that, on the one hand, as high as possible a signal fraction of the scattered light is detected and, on the other hand, no direct reflections from the glass surface into the detection beam path may occur.

Another aspect of the invention is a measuring system for performing light scattering measurements comprising a device having at least one focusing element by means of which electromagnetic radiation can be focused onto a sample, a detector and a detection optical system by means of which electromagnetic radiation scattered by the sample can be guided to the detector. In addition, the measuring system comprises a flat sample carrier having such a design that a sample consisting of a single droplet can form an interface with it. In addition, said at least one focusing element and the detection optical system are arranged in such a way that the beam paths of the electromagnetic radiation incident on the sample and of the scattered radiation detected by the detection optical system will cross the interface.

The measuring system thus comprises a flat sample carrier in addition to a device by means of which electromagnetic radiation can be emitted and scattered radiation detected. In the simplest case, the carrier may be a flat plate. It must be at least substantially transparent to the electromagnetic radiation employed in the regions designated for samples. Preferably, it is made of glass.

The excitation and detection occur through the flat sample carrier and the interface formed between the sample and the flat sample carrier. Thus, the beam path crosses only flat interfaces and is therefore relatively easily controlled with respect to undesirable reflections.

According to an advantageous embodiment, the detection optical system defines an optical axis (z). The latter is (at least substantially) perpendicular to the sample carrier (xy plane) and forms the center axis for the annular beam or the focusing element. The detection optical system is capable of detecting the radiation scattered by the sample from the detection volume towards the z axis and under an angle with the z axis (half angle divergence) of up to 48°, preferably up to 44°. A half angle divergence of 44° results in a numerical aperture of 0.7. The exciting radiation guided by the focusing element towards the focus forms an angle of from 51° to 59° with the z axis. Thus, the exciting radiation crosses the sample carrier and the interfaces under a flatter angle as compared to the scattered radiation detected by the detection optical system that originates from the detection volume.

The focusing element focuses the exciting annular beam onto the sample under an upper limiting numerical aperture of at least 0.84 (corresponding to)57.1°, preferably 0.86 (corresponding to)59.3°, or a lower limiting numerical aperture of at most 0.82 (corresponding to)55.1°, preferably 0.78 (corresponding to)51.2°. This ensures a sufficient angular distance to the detection optical system.

The sample carrier is preferably a microtitration plate, i.e., a standard component comprising a large number of mutually isolated measuring fields in rows and columns.

With the measuring system according to the invention, it is possible to apply a large number of samples respectively as individual droplets to a single flat sample carrier and to perform a large number of measurements in a short time and in automated operation thereon.

The measuring system has particular advantages if it additionally has an automated positioning unit based on image data by means of which the diffractionlimited laser focus can be positioned approximately in the center of the small volume of preferably below 1 μl of the protein solutions to be examined. This allows a rapid change from sample to sample under reproducible measuring conditions and thus the use of the laser light scattering process in the form of a high throughput process for systematic protein crystallization.

For example, a system of several precision translation stages with spindle drives and step motors controlled by microprocessors may be used as the positioning unit. Alternatively, piezo-driven stages are also suitable. The positioning accuracy should be significantly smaller than the dimension of the sample droplets, a positioning accuracy of a few micrometers having proven useful.

Another aspect of the invention is a process for performing light scattering measurements in which electromagnetic radiation is focused onto a sample and radiation scattered from the sample is detected, wherein the sample is in the form of a droplet sharing an interface with a flat sample carrier, and wherein the application of the electromagnetic radiation and the detection of the scattered radiation is effected through the flat sample carrier and the interface. For the process, the use of the device and measuring system described above suggests itself.

The sample is in the form of a single droplet brought into contact with the sample carrier. This means that the sample forms a self-contained phase interface wherein part of its surface forms an interface with the sample carrier while the remaining part forms a liquid/gaseous phase interface with the gaseous environment (air), resulting in a stable condition. The shape of the droplet is determined in the known way by the cohesive forces within the droplet and the adhesive forces towards the surface of the sample carrier.

Preferably, the sample, i.e., the small aqueous liquid droplet in which the proteins to be examined are dissolved, is pipetted directly onto the glass bottom of the flat element under a layer of a liquid immiscible with the sample, preferably an oil or paraffin layer. The droplet will displace the paraffin or oil from the glass bottom and sit directly on the bottom in a hemispherical shape. This can be realized even for extremely small sample volumes, such as volumes of below 1 μl or even for 100 nl and can be performed with needle-based pipetting robots in automated operation. The oil or paraffin layer protects the small amounts of liquid from drying up. Another advantage is the fact that, in addition, the sample carrier can have a simple design even for a large number of droplets. For example, it may also have merely a few larger separate cells, since not every individual droplet must be added into a separate compartment of the sample carrier. The oil and paraffin surrounding the droplet in a way replaces the walls of a separate sample compartment and prevents the individual droplets from coalescing.

The sample is often applied in the form of small droplets, especially in the case of protein solutions within the scope of crystallization experiments; such droplets may either sit on the bottom of a sample carrier (“sitting drop”) or hang from the bottom of a sample carrier or glass slide (“hanging drop”). The invention offers the possibility to perform light scattering measurements even for such an unconventional geometry of the sample. Due to the effective suppression of undesirable interferences, the curved surfaces of the droplets being close to the focus can also be tolerated.

According to an advantageous embodiment of the invention, in order to achieve further reduction of undesirable radiation (reflections on interfaces and the like) in the detected signal, the electromagnetic radiation focused onto the sample has several radiation components of different wavelengths; in particular, two different light or laser sources can be selected for this purpose. In addition, different spectral components of the scattered radiation are detected separately. This enables a differential intensity to be measured. In order for this measure to cause a sufficient increase in accuracy, the electromagnetic radiation should preferably contain at least two different radiation components whose wavelengths differ by at least 50 nm, preferably by at least 120 nm.

The reflection of radiation on an interface can be described by means of the Fresnel equations. Thus, the reflection coefficient of an interface between two materials with refractive indices n and n′ can be calculated as follows:

$$R = \frac{{I}_{R}}{{I}_{E}} = \frac{{( {n}^{′} - n )}^{2}}{{( {n}^{′} + n )}^{2}}$$

where R=reflectance, I_{R}=reflected intensity (incidence perpendicular to the surface), I_{E}=irradiated intensity, n and n′=refractive indices of the adjoining materials.

Thus, a reflection coefficient of about 4% results for the transition of a laser beam from air (n=1) into a typical glass (n′=1.5). For small variations, the wavelength has only a minor influence on the reflection coefficient. At the same time, however, the scattering intensity of small particles is a function of the fourth power of the wavelength, so that small differences in wavelength manifest themselves clearly in different scattering intensities. Now, if the difference in scattering intensities at two different wavelengths rather than the absolute scattering intensity at one wavelength is used as the basis for a light scattering experiment, a measured quantity is obtained that is relatively insensitive towards distortions of the measured signal by reflection components. If different fractions of reflected light enter the detection optical system in successive measurements on the same sample, the measuring results are highly distorted in one experiment with one wavelength. In an experiment with two wavelengths, the intensities of the two wavelengths would be changed in the same way, but the difference of the two intensities would be only weakly affected. Therefore, this approach offers the opportunity to perform light scattering measurements with high precision even in the presence of undesirable reflections.

For the embodiment with two radiation sources, the device according to the invention is to be extended by an optical means that enables the beams from the two radiation sources to be superimposed, for example, with a dichroic mirror that reflects the wavelength of one beam and transmits that of the other. Other optical means having the same effect may be used. Said superposition of the two radiation components can be effected particularly simply in the beam path upstream from the beam shaping optical system. Further, at least one further optical means is necessary to separate the radiation components from each other in the detection beam path or to guide them to different detectors; a dichroic mirror, for example, may be employed for this purpose too.

At the beginning of a measurement, the powers of the two laser beam sources are adjusted in such a way that the signal strength recorded on both detectors is identical when measuring a standard sample without scattering particles, for example, a blank solution merely consisting of solvent, buffer etc, but does not contain any proteins. Now, if the standard sample or blank solution is replaced by a “true sample”, i.e., for example, a solution with proteins as scattering particles, the signal strength for the detection channel having a shorter wavelength increases more strongly as compared to the detection channel having a longer wavelength. The difference is a measuring signal that is proportional to the scattering intensity, but is only slightly distorted by reflection effects.

An embodiment of the invention with more than two lasers of different wavelengths is also possible. In this case, only in-coupling and out-coupling optical systems as well as detectors for the further lasers will have to be supplemented. The individual wavelengths are superposed and separated by different dichroic mirrors. In order to compensate for different laser intensities and spectral sensitivities of the detectors, an intensity measurement with a sample having no scattering particles (e.g., without proteins) must again be performed at first. All the other measurements with the substances to be examined are based on this reference measurement, and a relative scattering intensity is obtained by division. If a linear detector characteristic is assumed, a series of relative scattering intensities that increase proportionally with ν4 (with ν=frequency of the exciting laser radiation) is obtained for the different detectors. The proportionality constant is a measure of the scattering cross section of the sample examined and is only a little distorted by reflection components.

An embodiment of the invention in which the exciting light has a continuous spectral distribution may also be contemplated. In this case, a spectrometer is preferably employed as the detector. On the condition that the sample exhibits no absorption in the considered range of wavelengths, a relative intensity course increasing proportionally with ν⁴ can be expected upon referencing to a measurement on a sample with no scattering particles. The scattering spectrum of a sample with scattering particles is divided by the scattering spectrum of a sample without scattering particles (e.g., without proteins). A mathematical fitting analysis (e.g., according to the least squares principle) may subsequently be used to approximate the course of the relative scattering intensity by an analytical expression. This yields a proportionality factor k that is a measure of the scattering cross section of the solution.

$${I}_{rel} ( ν ) = \frac{{I}_{Pr .} ( ν )}{{I}_{0} ( ν )} = k * {ν}^{4}$$

where Iᵣₑₗ(ν) are the relative scattering intensities as a function of the wavelength, I₀(ν) and I_{Pr}(ν) are the intensities of the reference sample (without scattering particles) and the sample to be examined, ν is the frequency, and k is a proportionality factor corresponding to the scattering cross section of the sample.

With the process described, protein-protein interactions can be determined in solution without markers by means of laser light scattering measurements. A very narrow range of weakly attractive interactions defines the limits within which protein single crystals can form. These interactions are affected by the properties of the solution. By means of the laser light scattering measurements, the interactions of the proteins are measured under different solution conditions, establishing those compositions of the solution that favor protein crystallization. From the selected solution approaches, new solution conditions of which a further approximation to the sought crystallization window is to be expected can be calculated by means of mathematical optimization algorithms. A set of further different protein solutions is mixed automatically in the calculated compositions and examined for the protein-protein interactions by laser light scattering measurements. The iteration of the procedure described is supposed to approximate the crystallization parameters closer to the crystallization window with each cycle until a protein single crystal is formed.

### BRIEF DESCRIPTION OF THE DRAWINGS

In the following, the present invention is again further illustrated by means of exemplary embodiments in connection with the drawings without limitation of the scope of protection, which is defined by the claims, wherein:

FIG. 1 shows an embodiment of the invention with one light source.

FIG. 2 shows an embodiment of the invention with two light sources.

FIG. 3 shows an embodiment of the invention with three light sources.

FIG. 4 shows an embodiment of the invention with a polychromatic light source.

### MODES FOR CARRYING OUT THE INVENTION

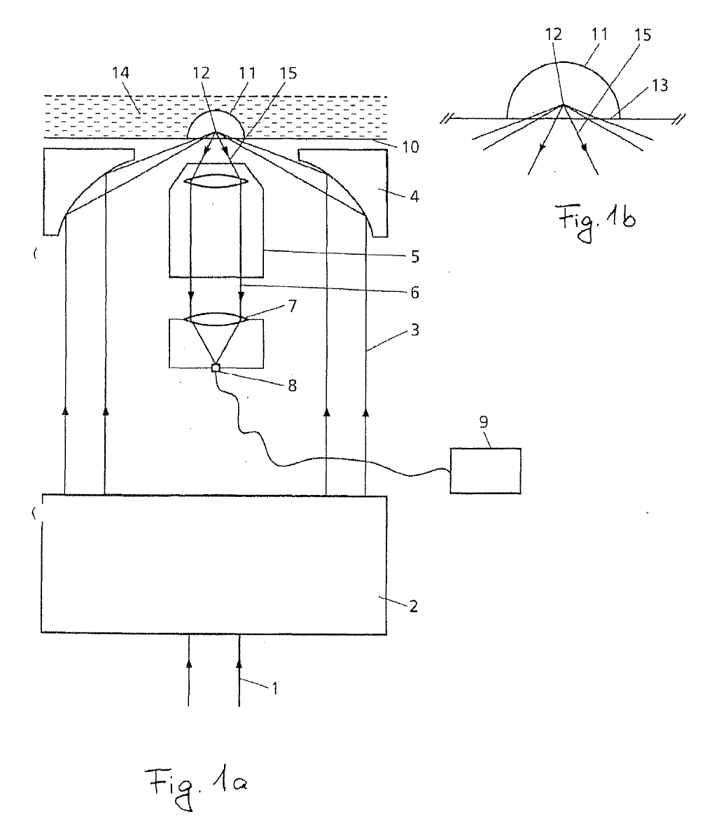

FIG. 1a schematically represents the individual components of the excitation and detection optical systems, FIG. 1b represents an enlarged view of FIG. 1a and shows a sketch of the sample droplet 11 sitting on the bottom of microtitration plate 10 and the beam paths of the incident radiation 3 and detected radiation 15.

A collimated laser beam 1 is converted to a collimated annular beam 3 by a beam-shaping optical system 2. This may be achieved by a sequence of two identical axicones (glass cones) pointing towards each other with their apices. The laser beam 1 is generated by a temperature-stabilized diode laser coupled into a single mode fiber. After the beam is coupled out of the fiber, the intensity distribution has a pure Gaussian profile (TEM-00 mode), and the beam diameter is 6 mm, for example. After the beam shaping by the axicones 2, an annular beam 3 with an interior diameter of 20 mm and an exterior diameter of 26 mm is obtained.

The collimated annular beam 3 strikes the parabolic mirror 4 and is focused onto the focal point 12 in sample 11 covered by a layer of liquid 14 immiscible with sample 11. It passes the glass bottom of a microtitration plate 10 and crosses the interface 13 formed by the bottom of sample 11 and the microtitration plate 10. The exciting annular beam 3 is irradiated under an angular range of from 51° to 59° (half angle divergence), corresponding to limiting numerical apertures of from 0.78 to 0.86. The generated scattered radiation 15 is collected by the microscope objective 5 placed in the center of parabolic mirror 4 at an angle of from 0° to 44° (half angle divergence), which corresponds to a numerical aperture of 0.7, and again formed into a collimated beam 6. The latter beam is focused onto a single mode fiber 8 by means of another optical system 7. Fiber 8 conducts the scattered light signal to a sensitive photodetector 9, which may be a photomultiplier or an avalanche photodiode.

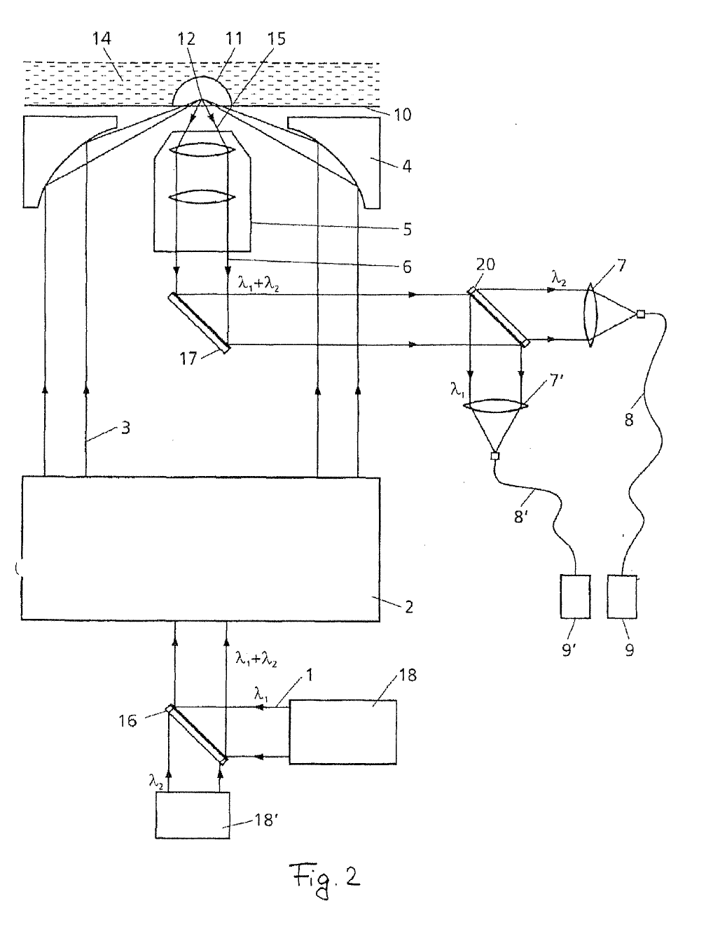

FIG. 2 shows a device according to the invention with two radiation sources 18, 18′. The two laser beam sources 18 and 18′ (e.g., a diode laser at 658 nm and a frequency-doubled Nd:YAG laser at 532 nm) respectively emit a collimated laser beam 1, 1′. Via a dichroic mirror 16, which reflects one wavelength and lets the other wavelength pass, the two beams 1, 1′ are superimposed. In a beam-shaping optical system 2, both beams are respectively reshaped into a collimated annular beam 3. The two superimposed annular beams 3 are focused by the parabolic mirror 4 into the sample volume 11 without chromatic aberration occurring, the scattered radiation 15 is collected by the chromatically corrected microscope objective 5 and deflected as a collimated beam 6 via an out-coupling mirror 17 onto another dichroic mirror 20. Here, the wavelengths are separated and guided by two separate optical systems 7, 7′ onto two single-mode fibers 8, 8′ and transmitted to two detectors 9, 9′. Again, photomultipliers or avalanche photodiodes are employed as detectors 9, 9′.

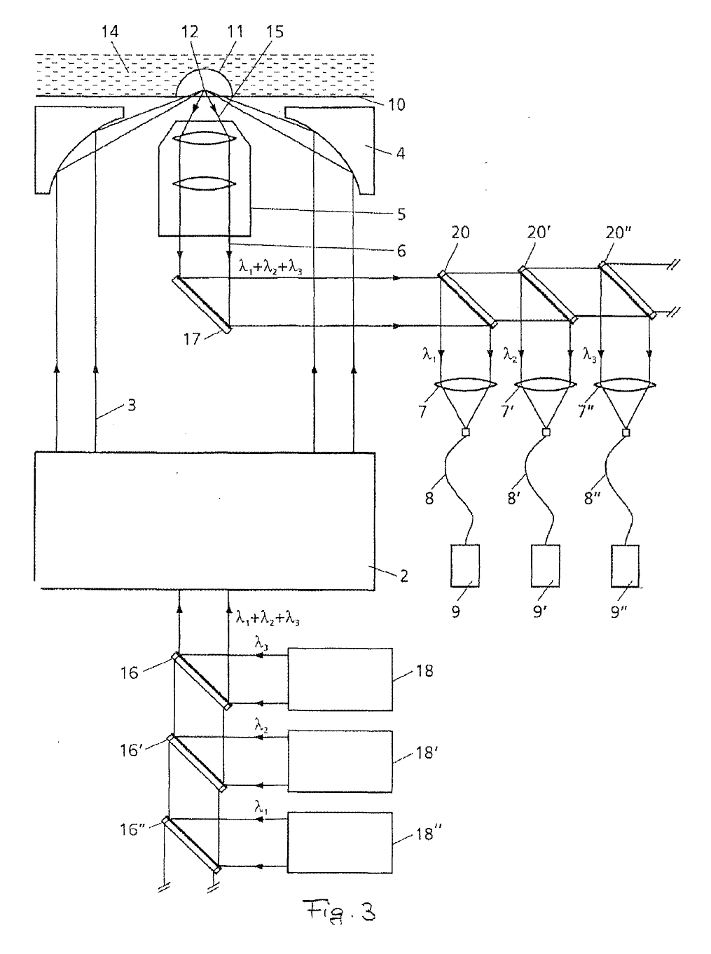

FIG. 3 shows a device according to the invention with three (or more) radiation sources 18, 18′, 18″. Apart from that, the number of dichroic mirrors 16, 16′, 16″ for superimposing the beams of the different lasers and the number of the dichroic mirrors 20, 20′, 20″ for separating the radiation components of the scattered radiation 15, the number of optical systems 7, 7′, 7″, the number of fibers 8, 8′, 8″ and the number of detectors 9, 9′, 9″ are increased as compared to FIG. 2.

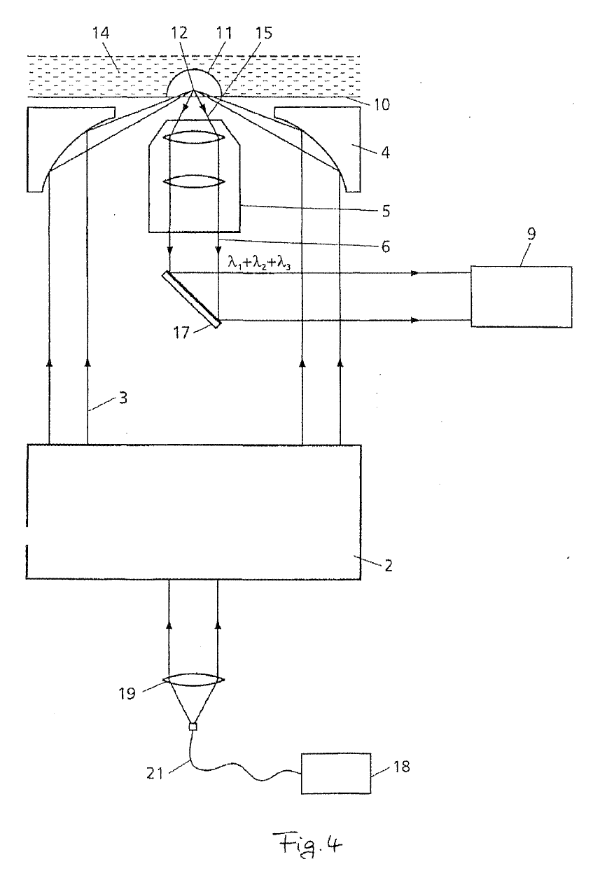

FIG. 4 shows a possible arrangement involving excitation with a continuous spectral distribution. It includes a polychromatic light source 18 and a spectrometer as the detector 9. The radiation from light source 18 is ideally guided through a fiber (21) and an out-coupling optical system (19) into the beam-shaping optical system 2. The light source 18 may be a classical light source (halogen lamp, discharge lamp) or a laser source (e.g., self phase modulation of a femtosecond laser in an optical fiber).

### LIST OF REFERENCE SYMBOLS

1 laser beam
2 beam-shaping optical system
3 annular beam
4 parabolic mirror
5 microscope objective
6 collimated beam of scattered light
7 focusing optical system for the beam of scattered light
8 optical waveguide fiber
9 photodetector
10 microtitration plate
11 sample
12 focus
13 interface
14 layer of liquid
15 scattered radiation
16 dichroic mirror
17 out-coupling mirror
18 radiation source
19 out-coupling optical system
20 dichroic mirror
21 optical waveguide fiber

1-27. (canceled)

28. A device for performing light scattering measurements, comprising
at least one focusing element for focusing electromagnetic radiation onto a sample,
a detector,
an annular beam source for the generation of an annular beam, and
a detection optical system, wherein electromagnetic radiation scattered by the sample is guided to the detector,
and wherein the at least one focusing element can cause the annular beam to be focused on a focal point within the sample, and that the detection optical system can detect electromagnetic radiation scattered by the sample that propagates within a space surrounded by the annular beam.

29. The device according to claim 28 wherein said detection optical system is arranged within the space surrounded by the annular beam.

30. The device according to claim 28 wherein said detection optical system has a numerical aperture of at least 0.6.

31. The device according to claim 28 wherein said detection optical system comprises a microscope objective.

32. The device according to claim 28 wherein said detection optical system provides that substantially only electromagnetic radiation originating from a defined detection volume and into the detection optical system may arrive at the detector.

33. The device according to claim 32 wherein the detection volume is within the focal point of the annular beam.

34. The device according to claim 28 wherein said focusing element is reflective.

35. The device according to claim 28 wherein said focusing element has an annular shape.

36. The device according to claim 28 wherein said focusing element comprises a parabolic minor.

37. The device according to claim 28 wherein said focusing element generates an approximately radial-symmetrically formed focus in the sample.

38. The device according to claim 28 wherein a focal diameter of smaller than 30 μm can be generated.

39. The device according to claim 28 comprising a beam-shaping optical system for shaping the annular beam.

40. The device according to claim 39 wherein said beam-shaping optical system comprises two axicones pointing towards each other with their apices.

41. The device according to claim 28 wherein electromagnetic radiation with radiation components having at least two different wavelengths can be applied to the sample.

42. The device according to claim 41 comprising a plurality of detectors and at least one guide for guiding different spectral radiation components of the scattered radiation to different detectors.

43. The device according of claim 28 wherein electromagnetic radiation having a continuous spectral distribution can be applied to the sample.

44. The device according to claim 43 wherein the detector is a spectrometer.

45. A measuring system for performing light scattering measurements comprising
at least one focusing element for focusing electromagnetic radiation onto a sample, a detector, and a detection optical system for guiding electromagnetic radiation scattered by the sample to the detector, and
a flat sample carrier that provides for an interface with a sample consisting of a single droplet, wherein said at least one focusing element and the detection optical system cooperate so that a beam path of the electromagnetic radiation incident on the sample and a beam path of the scattered radiation detected by the detection optical system each cross the interface.

46. The measuring system according to claim 45 wherein said flat sample carrier accommodates a plurality of individual sample droplets separated from one another.

47. The measuring system according to claim 45 wherein said flat sample carrier comprises a microtitration plate having a bottom that is transparent to the electromagnetic radiation incident on the sample.

48. The measuring system according to claim 45 further comprising a positioning unit for adjusting the position of the flat sample carrier relative to a focal point of the electromagnetic radiation.

49. A process for performing light scattering measurements comprising applying and focusing electromagnetic radiation onto a sample and detecting radiation scattered by the sample, wherein the sample is a droplet sharing an interface with a flat sample carrier, and the application of the electromagnetic radiation and the detection of the scattered radiation are effected through the flat sample carrier and the interface.

50. The process according to claim 49 wherein the droplet is covered by a layer of liquid that acts against evaporation of the sample.

51. The process according to claim 49 wherein a volume of the sample is smaller than 1 μl.

52. The process according to claim 49 wherein the electromagnetic radiation focused onto the sample has a plurality of radiation components of different wavelengths, and different spectral components of the scattered radiation are detected separately.

53. The process according to claim 49 wherein the sample droplet sits as a droplet on the flat sample carrier.

54. The process according to claim 49 wherein the sample droplet hangs as a droplet from a bottom of the flat sample carrier.
